(19) United States
(12) Patent Application Publication
(10) Pub. No.: US 2021/0094011 A1
(43) Pub. Date: Apr. 1, 2021

(54) METHOD FOR PREPARING VESICLE, HOLLOW NANOSTRUCTURE, AND METHOD FOR PREPARING THE SAME

(71) Applicant: BOE TECHNOLOGY GROUP CO., LTD., Beijing (CN)

(72) Inventor: Kang PENG, Beijing (CN)

(21) Appl. No.: 16/938,446

(22) Filed: Jul. 24, 2020

(30) Foreign Application Priority Data
Sep. 26, 2019 (CN) 201910918787.2

(51) Int. Cl. B01J 13/06; B01J 13/20; C01G 11/02; C01G 9/08; C01G 49/12; C01G 3/12; C01G 45/00

(52) U.S. Cl. CPC B01J 13/06; B01J 13/203; C01G 11/02; B82Y 30/00; C01G 49/12; C01G 3/12; C01G 45/00; C01G 9/08

(57) ABSTRACT

The present disclosure provides a method for preparing a vesicle, a hollow nanostructure, and a method for preparing the same. The preparation method of the vesicle includes: mixing and evenly stirring an aqueous solution of cetyl trimethyl ammonium bromide and an aqueous solution of tetraphenylethylene-bisphenol A; and allowing a stirred aqueous solution including cetyl trimethyl ammonium bromide and tetraphenylethylene-bisphenol A to stand for a first preset period to obtain an aggregate vesicle of cetyl trimethyl ammonium bromide and tetraphenylethylene-bisphenol A.

### CROSS-REFERENCE TO RELATED APPLICATION

This application claims a priority to Chinese Patent Application No. 201910918787.2 filed on Sep. 26, 2019, the disclosures of which are incorporated in their entirety by reference herein.

### TECHNICAL FIELD

The present disclosure relates to the technical field of preparing nanomaterial, in particular, to a method for preparing a vesicle, a hollow nanostructure and a method for preparing the same.

### BACKGROUND

In the related art, the hollow material is usually prepared by the template method. In the template method, the product or its precursor on the surface of the template is first coated by physical adsorption or chemical reaction to form a core/shell composite structure, and then the template is removed by calcination or other physical and chemical reactions to obtain a hollow structural material having a shape similar to that of the template. Common templates can be divided into hard templates and soft templates. The hard template method uses solid particle units of spherical or other shapes as templates. The hard template method generally needs surface modification to stabilize the core/shell layer structure, the synthesis process is relatively complicated, and changes in preparation conditions have a greater impact on the product, thereby limiting the large-scale use of this method. The soft template method does not need solid particles as templates, and thus eliminates template synthesis operations. The preparation process is more convenient and rapid, and the application prospect is relatively good. Although the preparation of the soft template is relatively simple compared to that of the hard template, the preparation of the soft template is still complicated. Besides, the particle size distribution of the product prepared by the soft template is uneven, resulting in uneven particle size of the hollow nanostructure formed subsequently, while the hollow nanostructure prepared by the soft template used in the related art also has the problem of environmental pollution due to the need of a large amount of organic solvents.

In summary, the hollow nanostructure prepared by the soft template used in the related art has a complicated process, and the particle size distribution of the product prepared by the soft template is uneven, resulting in uneven particle size of the hollow nanostructure formed subsequently.

### SUMMARY

In one aspect, an embodiment of the present disclosure provides a method for preparing a vesicle, including: mixing and evenly stirring an aqueous solution of cetyl trimethyl ammonium bromide and an aqueous solution of tetraphenylethylene-bisphenol A; and allowing a stirred aqueous solution including cetyl trimethyl ammonium bromide and tetraphenylethylene-bisphenol A to stand for a first preset period to obtain an aggregate vesicle of cetyl trimethyl ammonium bromide and tetraphenylethylene-bisphenol A.

Exemplarily, an amount-of-substance concentration ratio of the aqueous solution of cetyl trimethyl ammonium bromide to the aqueous solution of tetraphenylethylene-bisphenol A is 1:8.

Exemplarily, the first preset period is in a range from 0.5 h to 1 h.

In another aspect, an embodiment of the present disclosure provides a method for preparing a hollow nanostructure, including: preparing a vesicle, and embedding a metal cation on a surface of the vesicle to obtain a metal cation vesicle structure, in which the preparing the vesicle includes: mixing and evenly stirring an aqueous solution of cetyl trimethyl ammonium bromide and an aqueous solution of tetraphenylethylene-bisphenol A, and allowing a stirred aqueous solution including cetyl trimethyl ammonium bromide and tetraphenylethylene-bisphenol A to stand for a first preset period to obtain an aggregate vesicle of cetyl trimethyl ammonium bromide and tetraphenylethylene-bisphenol A; adding a non-metallic compound to an aqueous solution including the metal cation vesicle structure, so as to react the metal cation with a nonmetal anion in the non-metallic compound to form a metal compound, thereby obtaining a metal compound vesicle structure; and washing an aqueous solution including the metal compound vesicle structure to remove the vesicle structure, thereby obtaining a metal compound hollow nanostructure.

Exemplarily, the preparing the vesicle and the embedding the metal cation on the surface of the vesicle includes: mixing and evenly stirring the aqueous solution of cetyl trimethyl ammonium bromide, the aqueous solution of tetraphenylethylene-bisphenol A, and an aqueous solution of metal chloride; and allowing a stirred aqueous solution to stand for the first preset period to obtain a vesicle with a metal cation embedded on a surface.

Exemplarily, an amount-of-substance concentration ratio of the aqueous solution of cetyl trimethyl ammonium bromide to the aqueous solution of tetraphenylethylene-bisphenol A to the aqueous solution of metal chloride is 1:8:2.

Exemplarily, the metal cation is a divalent metal cation.

Exemplarily, the divalent metal cation is selected from a group consisting of cadmium ion (Cd²⁺), zinc ion (Zn²⁺), ferrous ion (Fe²⁺), copper ion (Cu²⁺), and manganese ion (Mn²⁺).

Exemplarily, the adding the non-metallic compound to the aqueous solution including the metal cation vesicle structure, so as to react the metal cation with the nonmetal ion in the non-metallic compound to form the metal compound, thereby obtaining the metal compound vesicle structure, includes: adding thioacetamide as an organic sulfur source to the aqueous solution including the metal cation vesicle structure, followed by mixing and evenly stirring; adjusting a pH value of a stirred aqueous solution, so that the stirred aqueous solution is an alkaline aqueous solution; and placing the alkaline aqueous solution in a water bath at a preset temperature for heating for a second preset period while stirring to obtain a metal sulfide vesicle structure.

Exemplarily, an amount-of-substance concentration of the thioacetamide as the organic sulfur source is 500 mol/L to 1000 mol/L.

Exemplarily, the adjusting the pH value of the stirred aqueous solution, so that the stirred aqueous solution is the alkaline aqueous solution, includes: adding a sodium hydroxide aqueous solution to the stirred aqueous solution dropwise, until the pH value of the alkaline aqueous solution is in a range from 8 to 8.5.

Exemplarily, the preset temperature is in a range from 60° C. to 75° C., and the second preset period is in a range from 4 h to 6 h.

Exemplarily, the first preset period is in a range from 0.5 h to 1 h.

Exemplarily, the washing the aqueous solution including the metal compound vesicle structure to remove the vesicle structure, thereby obtaining the metal compound hollow nanostructure, includes: centrifuging the aqueous solution including the metal compound vesicle structure, followed by sucking and removing a supernatant to reserve a lower precipitate; and repeating the following step for a preset number of times, until the vesicle structure in the precipitate is completely removed to obtain a metal compound hollow nanostructure: adding water to the precipitate to continue the centrifuging, followed by sucking and removing a supernatant.

An embodiment of the present disclosure further provides a hollow nanostructure, prepared by the above method provided by the embodiments of the present disclosure and having a hollow cavity/shell layer structure, the shell layer covering the hollow cavity, and the shell layer being made of a metal compound composed of a metal element and a non-metallic element.

Exemplarily, a valence of the metal element matches a valence of the non-metallic element.

Exemplarily, the metal element includes one or a combination of a group consisting of cadmium, zinc, iron, copper, and manganese; and the non-metallic element includes sulfur.

Exemplarily, a shape of the hollow cavity covered by the shell layer structure is a sphere, a diameter of the sphere is in a range from 30 nm to 50 nm, and a thickness of the shell layer structure is in a range from 5 nm to 10 nm.

### BRIEF DESCRIPTION OF THE DRAWINGS

In order to illustrate the technical solutions of the present disclosure in a clearer manner, the drawings desired for the embodiments of the present disclosure will be briefly hereinafter briefly. Obviously, the following drawings merely relate to some embodiments of the present disclosure. Based on these drawings, a person skilled in the art may obtain the other drawings without any creative effort.

FIG. 1 is a schematic view showing the method for preparing the vesicle according to an embodiment of the present disclosure;

FIG. 2 is a schematic view showing the molecular structure of TPE-BPA according to an embodiment of the present disclosure;

FIG. 3 is a schematic view showing the molecular structure of CTAB according to an embodiment of the present disclosure;

FIG. 4 is a schematic view showing the structure of the aggregate vesicle of CTAB and TPE-BPA according to an embodiment of the present disclosure;

FIG. 5 is a schematic view showing the method for preparing the hollow nanostructure according to an embodiment of the present disclosure;

FIG. 6 is a schematic view showing the metal cation vesicle structure according to an embodiment of the present disclosure;

FIG. 7 is a schematic view showing the metal compound vesicle structure according to an embodiment of the present disclosure;

FIG. 8 is a schematic view showing the metal compound hollow structure according to an embodiment of the present disclosure;

FIG. 9 is a transmission electron microscope characterization result image of the TPE-BPA/CTAB vesicle with Fe²⁺ embedded on the surface according to an embodiment of the present disclosure;

FIG. 10 is a scanning electron microscope characterization result image of the CdS hollow nanosphere according to an embodiment of the present disclosure;

FIG. 11 is a scanning electron microscope characterization result image of the ZnS hollow nanosphere according to an embodiment of the present disclosure.

### DETAILED DESCRIPTION

A hollow nanosphere is attracting more and more attention as a nanomaterial having a spherical shell special structure with a hollow inside. The hollow nanosphere has advantages, such as low density, high specific surface and high surface activity, over other nanoscale solid ions. Since the hollow part can produce some properties based on the micro-encapsulation effect, the hollow nanosphere has potential application prospects in the fields of drug delivery, optoelectronic materials, highly selective catalysts, adsorbents, magnetic storage materials, sensor materials, etc.

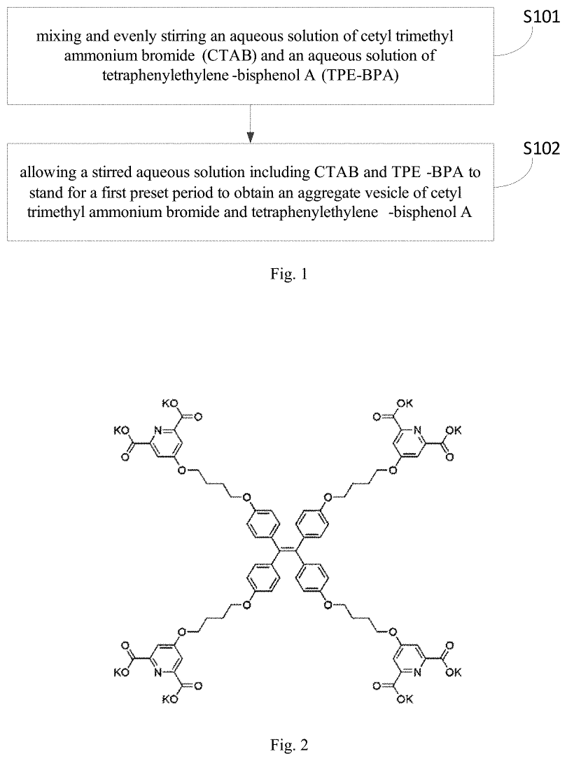

An embodiment of the present disclosure provide a method for preparing vesicles used to synthesize a hollow nanostructure, as shown in FIG. 1, including:

S101: mixing and evenly stirring an aqueous solution of cetyl trimethyl ammonium bromide (CTAB) and an aqueous solution of tetraphenylethylene-bisphenol A (TPE-BPA); and

S102: allowing a stirred aqueous solution including CTAB and TPE-BPA to stand for a first preset period to obtain an aggregate vesicle of cetyl trimethyl ammonium bromide and tetraphenylethylene-bisphenol A.

In the method for preparing the vesicle provided in the embodiments of the present disclosure, TPE-BPA and CTAB can be formed into a vesicle only by simplely mixing a aqueous solution, and eliminate the complicated vesicle synthesis steps, thereby making the vesicle preparation process easier and more convenient. When the vesicle is used as the soft template to synthesize the hollow nanostructure, the step of removing the template by calcination can also be removed, thereby simplifying the step of synthesizing the hollow nanostructure. At the same time, the vesicle formed by TPE-BPA and CTAB has good morphology stability and size uniformity, thereby ensuring the morphological uniformity of the synthesized hollow nanostructure.

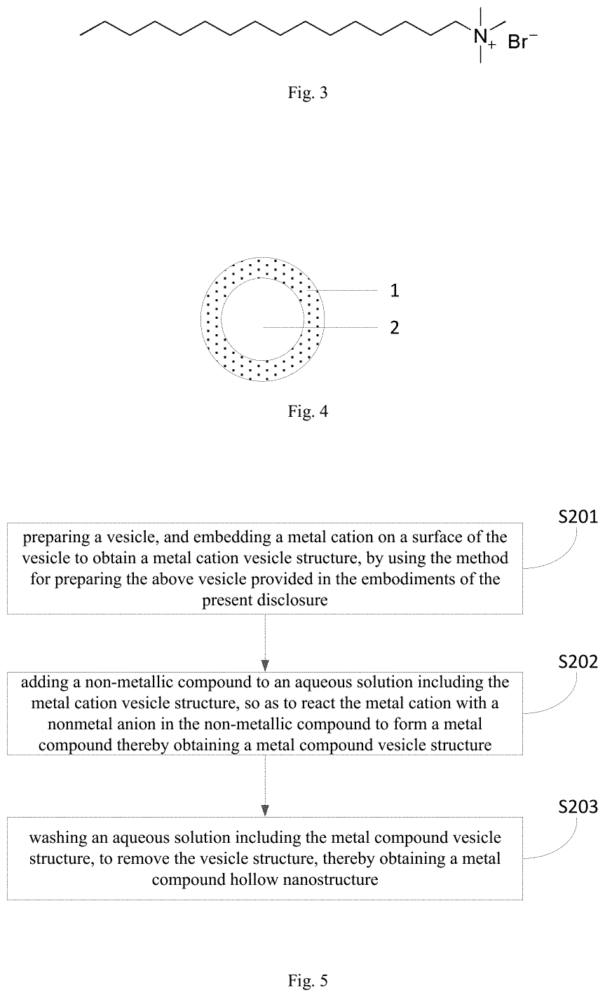

It should be noted that the TPE-BPA molecule is a common aggregation-induced fluorescent molecule, and the molecular structure of TPE-BPA is shown in FIG. 2. TPE-BPA is composed of a conjugated fluorescent group in the middle and 4 chelidamic acid head groups in the surrounding, and is negatively charged in an aqueous solution. CTAB belongs to a kind of surfactant molecule, and the molecular structure of CTAB is shown in FIG. 3. TPE-BPA and CTAB can rely on electrostatic self-assembly to form a stable neutral vesicle with a uniform size. The structure of the aggregate vesicle of CTAB and TPE-BPA is shown in FIG. 4. The vesicle 1 has a double-layer membrane structure, and the area 2 surrounded by the inner membrane is a hollow area. Moreover, the vesicle formed by TPE-BPA and CTAB can maintain stable morphology and uniform size in the pH value range from 5 to 10, thereby ensuring the morphological uniformity of the synthesized hollow nanostructure in the process of synthesizing the hollow nanostructure using the vesicle formed by TPE-BPA and CTAB as the template.

Exemplarily, an amount-of-substance concentration ratio of the aqueous solution of CTAB to the aqueous solution of TPE-BPA is 1:8. Therefore, CTAB and TPE-BPA can rely on electrostatic self-assembly to form a stable neutral vesicle with a uniform size.

Exemplarily, the first preset period is in a range from 0.5 h to 1 h.

In this way, the reaction can proceed sufficiently to obtain an aggregate vesicle of CTAB and TPE-BPA.

An embodiment of the present disclosure provides a method for preparing a hollow nanostructure, as shown in FIG. 5, including:

S201: preparing a vesicle, and embedding a metal cation on a surface of the vesicle to obtain a metal cation vesicle structure, by using the method for preparing the above vesicle provided in the embodiments of the present disclosure;

S202: adding a non-metallic compound to an aqueous solution including the metal cation vesicle structure, so as to react the metal cation with a nonmetal anion in the non-metallic compound to form a metal compound to obtain a metal compound vesicle structure; and

S203: washing an aqueous solution including the metal compound vesicle structure to remove the vesicle structure, thereby obtaining a metal compound hollow nanostructure.

The method for preparing the hollow nanostructure provided by the embodiments of the present disclosure uses the vesicle as the soft template. Due to the use of the method for preparing the vesicle provided by the embodiments of the present disclosure, the synthesis process of the vesicle is simple and convenient, and the preparation process of the hollow nanostructure is simplified. Since the vesicle formed by TPE-BPA and CTAB has good morphology stability and size uniformity, thereby ensuring the morphological uniformity of the prepared hollow nanostructure. In addition, the metal ions embedded on the surface of the vesicle and the non-metal ion in the solution can obtain a metal compound product on the surface of the vesicle template only by a simple chemical reaction, thereby further simplifying the synthesis step. In addition, in the preparation process of the hollow nanosphere provided in the embodiments of the present disclosure, the whole reaction can be completed in a single aqueous phase without introducing an organic solvent to obtain a two-phase microemulsion preparation template. In addition to optimizing the synthesis step, it can also reduce the introduction of the contaminating reagent.

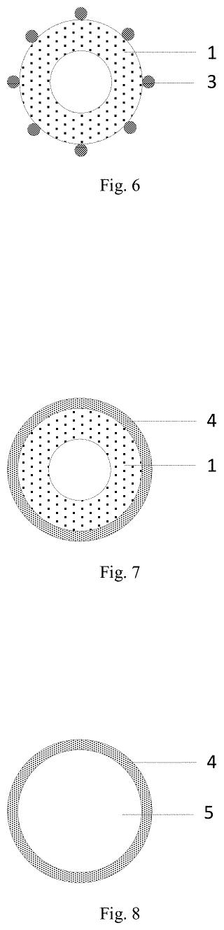

In the method for preparing the hollow nanostructure provided by the embodiments of the present disclosure, since TPE-BPA is composed of a conjugated fluorescent group in the middle and 4 chelidamic acid head groups in the surrounding and is negatively charged in an aqueous solution, a variety of metal ions can be combined with the chelidamic acid head groups in the TPE-BPA molecule through the coordination and the electrostatic interaction. As shown in FIG. 6, the metal cation 3 is embedded on the surface of the vesicle 1, in which the metal cation vesicle structure is positively charged. As shown in FIG. 7, the metal cation embedded on the surface of the vesicle 1 reacts with the nonmetal anion in the non-metallic compound to form the metal compound 4, thereby obtaining a metal compound vesicle structure. Subsequently, the vesicles can be removed by washing the aqueous solution including the metal compound vesicle structure, as shown in FIG. 8, thereby obtaining a hollow nanostructure having a hollow cavity 5/a metal compound 4 shell layer, in which the metal compound 4 shell layer covers the hollow cavity 5.

Exemplarily, the preparing the vesicle and the embedding the metal cation on the surface of the vesicle includes: mixing and evenly stirring the aqueous solution of CTAB, the aqueous solution of TPE-BPA, and an aqueous solution of metal chloride; and allowing a stirred aqueous solution to stand for the first preset period to obtain a vesicle with a metal cation embedded on a surface.

In the method for preparing the hollow nanostructure provided by the embodiments of the present disclosure, the formation of the vesicle and the embedment of the metal cation on the surface of the vesicle can be completed in the same step, thereby further simplifying the preparation step of the hollow nanostructure.

Exemplarily, an amount-of-substance concentration ratio of the aqueous solution of CTAB to the aqueous solution of TPE-BPA to the aqueous solution of metal chloride is 1:8:2.

For example, the amount-of-substance concentrations of the aqueous solution of CTAB, the aqueous solution of TPE-BPA, and the aqueous solution of metal chloride after the mixing are 50 μmol/L, 400 μmol/L, and 100 μmol/L, respectively. That is, the amount-of-substance concentration ratio of the aqueous solution of CTAB to the aqueous solution of TPE-BPA to the aqueous solution of metal chloride after the mixing is 1:8:2. Thus, a metal cation vesicle structure having stable morphology can be formed.

Exemplarily, the metal cation is a divalent metal cation.

In the method for preparing the hollow nanostructure provided by the embodiments of the present disclosure, the structure formed by the combination of the divalent metal cation and the vesicle is more stable.

The divalent metal cation may be, for example, selected from a group consisting of cadmium ion (Cd²⁺), zinc ion (Zn²⁺), ferrous ion (Fe²⁺), copper ion (Cu²⁺), and manganese ion (Mn²⁺).

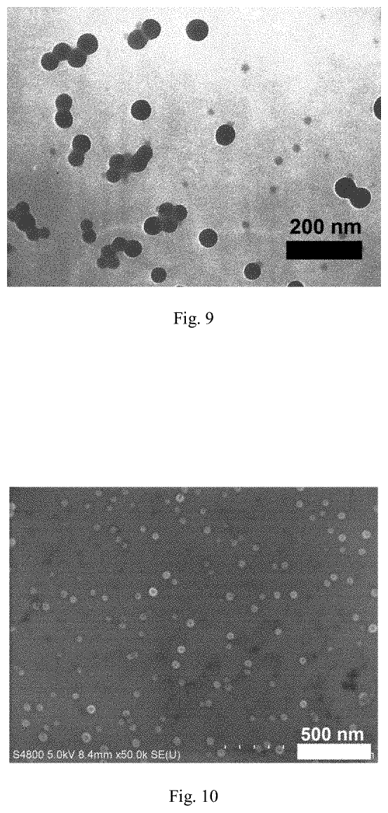

For example, a transmission electron microscope (TEM) characterization result of the TPE-BPA/CTAB vesicle with Fe²⁺ embedded on the surface is shown in FIG. 9.

Exemplarily, the adding the non-metallic compound to the aqueous solution including the metal cation vesicle structure, so as to react the metal cation with the nonmetal anion in the non-metallic compound to form the metal compound, thereby obtaining the metal compound vesicle structure, specifically includes: adding thioacetamide (TAA) as an organic sulfur source to the aqueous solution including the metal cation vesicle structure, followed by mixing and evenly stirring; adjusting a pH value of a stirred aqueous solution, so that the stirred aqueous solution is an alkaline aqueous solution; and placing the alkaline aqueous solution in a water bath at a preset temperature for heating for a second preset period while stirring to obtain a metal sulfide vesicle structure.

It should be noted that TAA can gradually hydrolyze in acidic or alkaline aqueous solutions to release H₂S or sulfur ions (S²⁻).

In the method for preparing the hollow nanostructure provided by the embodiments of the present disclosure, the stirred aqueous solution is an alkaline aqueous solution, so that TAA releases S²⁻, and the metal cation is completely precipitated, that is, the metal cation and the S²⁻ in the solution can obtain the metal sulfide on the surface of the vesicle template only by a simple chemical reaction. In the method for preparing the hollow nanostructure provided by the embodiments of the present disclosure, the alkaline aqueous solution is heated while stirring, so that the synthesis reaction can proceed sufficiently.

Of course, the material that can release other non-metal ions in solution can also be used.

Exemplarily, after TAA is added to an aqueous solution including a metal cation vesicle structure, the amount-of-substance concentration of TAA is in a range from 500 μmol/L to 1000 μmol/L.

For example, the amount-of-substance concentration of TAA added to the aqueous solution including the metal cation vesicle structure is 500 μmol/L.

Exemplarily, the adjusting the pH value of the stirred aqueous solution, so that the stirred aqueous solution is the alkaline aqueous solution, specifically includes: adding a sodium hydroxide (NaOH) aqueous solution to the stirred aqueous solution dropwise, until the pH value of the alkaline aqueous solution is in a range from 8 to 8.5.

For example, the concentration of the NaOH aqueous solution is 1%, and the pH value of the alkaline aqueous solution is 8.

Exemplarily, the preset temperature is in a range from 60° C. to 75° C. and the second preset period is in a range from 4 h to 6 h.

For example, the preset temperature may be 60° C., and the second preset period may be 5 h.

Exemplarily, the washing the aqueous solution including the metal compound vesicle structure to remove the vesicle structure, thereby obtaining the metal compound hollow nanostructure, includes: centrifuging the aqueous solution including the metal compound vesicle structure, followed by sucking and removing a supernatant to reserve a lower precipitate; and repeating the following step for a preset number of times, until the vesicle structure in the precipitate is completely removed to obtain a metal compound hollow nanostructure: adding water to the precipitate to continue the centrifuging, followed by sucking and removing the supernatant.

Next, taking the preparation of cadmium sulfide (CdS) hollow nanostructures as an example, the method for preparing the hollow nanostructure provided in the embodiments of the present disclosure is exemplified, and the preparation of cadmium sulfide hollow nanostructure includes the following steps:

S301: mixing and thoroughly stirring the aqueous solutions of TPE-BPA, CTAB, and cadmium chloride (CdCl₂) at the final amount-of-substance concentration of 50 μmol/L, 400 μmol/L, and 100 μmol/L, respectively, and allowing to stand for 0.5 h to obtain the vesicle with metal cations embedded on the surface;

S302: adding TAA to the solution so that the final amount-of-substance concentration of TAA is 500 μmol/L, followed by thoroughly stirring and mixing, adjusting the pH value of the solution to 8, placing the solution in a 60° C. water bath for heating to react for 5 h, and continuously stirring to make the synthesis reaction fully proceed to obtain a CdS vesicle structure; and

S303: concentrating and washing the solution including the CdS vesicle structure to remove the vesicle to obtain a CdS hollow nanostructure.

A scanning electron microscope (SEM) characterization result of the CdS hollow nanosphere is shown in FIG. 10.

Next, taking the preparation of zinc sulfide (ZnS) hollow nanostructures as an example, the method for preparing the hollow nanostructure provided in the embodiments of the present disclosure is exemplified, and the preparation of zinc sulfide hollow nanostructure includes the following steps:

S401: mixing and thoroughly stirring the aqueous solutions of TPE-BPA, CTAB, and zinc chloride (ZnCl₂) at the final amount-of-substance concentration of 50 μmol/L, 400 μmol/L, and 100 μmol/L, respectively, and allowing to stand for 0.5 h to obtain the vesicle with metal cations embedded on the surface;

S402: adding TAA to the solution so that the final concentration of TAA is 500 μmol/L, followed by thoroughly stirring and mixing, adjusting the pH value of the solution to 8, placing the solution in a 60° C. water bath for heating to react for 5 h, and continuously stirring to make the synthesis reaction fully proceed to obtain a ZnS vesicle structure; and

S403: concentrating and washing the solution including the ZnS vesicle structure to remove the vesicle to obtain a ZnS hollow nanostructure.

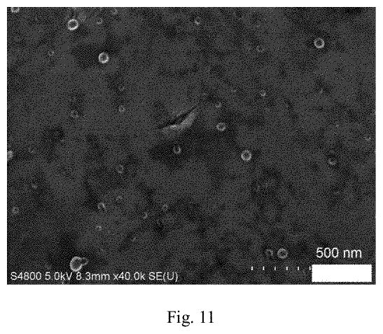

The SEM characterization result of ZnS hollow nanosphere is shown in FIG. 11.

An embodiment of the present disclosure provides a hollow nanostructure, prepared by the above method for preparing the hollow nanostructure provided by the embodiments of the present disclosure and having a hollow cavity/shell layer structure, the shell layer covering the hollow cavity, and the shell layer being made of a metal element and a non-metallic element.

Exemplarily, a valence of the metal element matches a valence of the non-metallic element.

Exemplarily, the metal element includes one or a combination of a group consisting of cadmium, zinc, iron, copper, and manganese; and the non-metallic element includes sulfur.

The hollow nanostructure provided in the embodiments of the present disclosure may be a metal sulfide hollow nanostructure. The material of the metal sulfide hollow structure has special optical, electrical and magnetic properties. For example, CdS can be used as a photoconductor and electronic material, while ZnS has a high refractive index and can be used for optical materials and photonic crystals.

Of course, the non-metallic element may also be other elements, for example, it may be a non-metallic element in the same group as sulfur, or a non-metallic element in the V group of the periodic table of the elements.

Exemplarily, in the hollow nanostructure provided by the embodiments of the present disclosure, a shape of the hollow cavity covered by the shell layer structure is a sphere, a diameter of the sphere is in a range from 30 nm to 50 nm, and a thickness of the shell layer structure is in a range from 5 nm to 10 nm.

In summary, in the method for preparing the vesicle, the method for preparing the hollow nanostructure, and the hollow nanostructures provided in the embodiments of the present disclosure, TPE-BPA and CTAB can be formed into a vesicle only by simply mixing a aqueous solution, and eliminate the complicated vesicle synthesis steps, thereby making the vesicle preparation process easier and more convenient. When the vesicle is used as the soft template to synthesize the hollow nanostructure, the step of removing the template by calcination can also be removed, thereby simplifying the step of synthesizing the hollow nanostructure. At the same time, the vesicle formed by TPE-BPA and CTAB has good morphology stability and size uniformity, thereby ensuring the morphological uniformity of the synthesized hollow nanostructure.

Obviously, it will be apparent to those skilled in the art that various modifications and changes can be made in the present disclosure without departing from the spirit and scope of the disclosure. Thus, if such modifications and variations of the present disclosure belong to the scope of the appended claims and equivalents thereof herein, the present application is intended to cover these modifications and variations.

What is claimed is:

1. A method for preparing a vesicle, comprising:
mixing and evenly stirring an aqueous solution of cetyl trimethyl ammonium bromide and an aqueous solution of tetraphenylethylene-bisphenol A; and
allowing a stirred aqueous solution comprising cetyl trimethyl ammonium bromide and tetraphenylethylene-bisphenol A to stand for a first preset period to obtain an aggregate vesicle of cetyl trimethyl ammonium bromide and tetraphenylethylene-bisphenol A.

2. The method of claim 1, wherein an amount-of-substance concentration ratio of the aqueous solution of cetyl trimethyl ammonium bromide to the aqueous solution of tetraphenylethylene-bisphenol A is 1:8.

3. The method of claim 1, wherein the first preset period is in a range from 0.5 h to 1 h.

4. The method of claim 1, wherein the vesicle has a double-layer membrane structure, and an area surrounded by an inner membrane is a hollow area.

5. A method for preparing a hollow nanostructure, comprising:
preparing a vesicle, and embedding a metal cation on a surface of the vesicle to obtain a metal cation vesicle structure, wherein the preparing the vesicle comprises: mixing and evenly stirring an aqueous solution of cetyl trimethyl ammonium bromide and an aqueous solution of tetraphenylethylene-bisphenol A, and allowing a stirred aqueous solution comprising cetyl trimethyl ammonium bromide and tetraphenylethylene-bisphenol A to stand for a first preset period to obtain an aggregate vesicle of cetyl trimethyl ammonium bromide and tetraphenylethylene-bisphenol A;
adding a non-metallic compound to an aqueous solution comprising the metal cation vesicle structure, so as to react the metal cation with a nonmetal anion in the non-metallic compound to form a metal compound, thereby obtaining a metal compound vesicle structure; and
washing an aqueous solution comprising the metal compound vesicle structure to remove the vesicle structure, thereby obtaining a metal compound hollow nanostructure.

6. The method of claim 5, wherein the preparing the vesicle and the embedding the metal cation on the surface of the vesicle comprises:
mixing and evenly stirring the aqueous solution of cetyl trimethyl ammonium bromide, the aqueous solution of tetraphenylethylene-bisphenol A, and an aqueous solution of metal chloride; and
allowing a stirred aqueous solution to stand for the first preset period to obtain a vesicle with a metal cation embedded on a surface of the vesicle.

7. The method of claim 6, wherein an amount-of-substance concentration ratio of the aqueous solution of cetyl trimethyl ammonium bromide to the aqueous solution of tetraphenylethylene-bisphenol A to the aqueous solution of metal chloride is 1:8:2.

8. The method of claim 5, wherein the metal cation is a divalent metal cation.

9. The method of claim 8, wherein the divalent metal cation is selected from a group consisting of cadmium ion (Cd²⁺), zinc ion (Zn²⁺), ferrous ion (Fe²⁺), copper ion (Cu²⁺), and manganese ion (Mn²⁺).

10. The method of claim 5, wherein the adding the non-metallic compound to the aqueous solution comprising the metal cation vesicle structure, so as to react the metal cation with the nonmetal ion in the non-metallic compound to form a metal compound, thereby obtaining a metal compound vesicle structure, comprises:
adding thioacetamide as an organic sulfur source to the aqueous solution comprising the metal cation vesicle structure, followed by mixing and evenly stirring;
adjusting a pH value of a stirred aqueous solution, so that the stirred aqueous solution is an alkaline aqueous solution; and
placing the alkaline aqueous solution in a water bath at a preset temperature for heating for a second preset period while stirring to obtain a metal sulfide vesicle structure.

11. The method of claim 10, wherein an amount-of-substance concentration of the thioacetamide as the organic sulfur source is 500 mol/L to 1000 mol/L.

12. The method of claim 10, wherein the adjusting the pH value of the stirred aqueous solution, so that the stirred aqueous solution is the alkaline aqueous solution, comprises:
adding a sodium hydroxide aqueous solution to the stirred aqueous solution dropwise, until the pH value of the aqueous solution is in a range from 8 to 8.5.

13. The method of claim 10, wherein the preset temperature is in a range from 60° C. to 75° C., and the second preset period is in a range from 4 h to 6 h.

14. The method of claim 5, wherein the first preset period is in a range from 0.5 h to 1 h.

15. The method of claim 5, wherein the washing the aqueous solution comprising the metal compound vesicle structure to remove the vesicle structure, thereby obtaining the metal compound hollow nanostructure, comprises:
centrifuging the aqueous solution comprising the metal compound vesicle structure, followed by sucking and removing a supernatant to reserve a lower precipitate; and
repeating the following step for a preset number of times, until the vesicle structure in the precipitate is completely removed to obtain the metal compound hollow nanostructure:
adding water to the precipitate to continue the centrifuging, followed by sucking and removing the supernatant.

16. A hollow nanostructure, having a hollow cavity/shell layer structure, the shell layer covering the hollow cavity, and the shell layer being made of a metal compound composed of a metal element and a non-metallic element.

17. The hollow nanostructure of claim 16, wherein a valence of the metal element matches a valence of the non-metallic element, the metal element comprises one or a combination of a group consisting of cadmium, zinc, iron, copper, and manganese; and the non-metallic element comprises sulfur.

18. The hollow nanostructure of claim 16, wherein a shape of the hollow cavity covered by the shell layer structure is a sphere, a diameter of the sphere is in a range from 30 nm to 50 nm, and a thickness of the shell layer structure is in a range from 5 nm to 10 nm.
